(19) United States
(12) Patent Application Publication
(10) Pub. No.: US 2008/0243534 A1
(43) Pub. Date: Oct. 2, 2008

(54) IDENTITY VERIFICATION METHOD

(76) Inventor: Serdar Mutlu, Istanbul (TR)

Correspondence Address: VENABLE, CAMPILLO, LOGAN & MEANEY, P.C., 1938 E. OSBORN RD, PHOENIX, AZ, 85016-7234, US

(21) Appl. No.: 12/055,277

(22) Filed: Mar. 25, 2008

(30) Foreign Application Priority Data
Mar. 26, 2007 (TR) A 2007/01941

(51) Int. Cl. G06Q 99/00

(52) U.S. Cl. 705/1

(57) ABSTRACT

This invention is a method to verify information of a person (user or customer) using credit cards in the electronic environment used in electronic commerce applications of a Customer System Operator—Application Service Provider ASP and conveying this information to the seller and thus completing the transaction

The present invention claims priority under 35 U.S.C. 119(a)-(d) through one or more of the treaties listed in MPEP 201.13 for an application and registration under the Turkish Patent Institute Patent Application No. A 2007/01941 having a filing date of 26 Mar. 2007 in the Turkish Patent Institute located in Ankara, Turkey and said foreign priority document is hereby incorporated by reference.

### FIELD OF THE INVENTION

This invention is related to identity verification in an electronic commerce.

### BACKGROUND

The use of electronic transaction is used in all facets of modem commercial transactions. In an information environment, an identity verification process is performed to identify whether a message actually belongs to the stated person. In face to face applications it is possible to use methods such as real signature, identification card, photo, etc.

Internet media commerce applications (e-business/e-commerce) payments may be done with credit cards and/or similar payment methods as in the traditional commerce, but such face to face verification methods discussed above are typically not possible. The simplest way an e-commerce transaction can be verified is by user name/password analysis. For example, in electronic commerce (“e-commerce”) on the Internet environment, credit card number, security number, digital signature is a verification tool that the user (customer) sends to the verification center. Alternatively, e-commerce transactions that require high levels of security may be verified by analyzing a created key and/or getting biometric data.

In a typical method, the verification service provider may be a bank or an independent entity. It is known that payments done on the Internet may be handled as MOTO (Mail Order—Telephony Order), but in case of customer claims all the responsibility belongs to the seller as their is no real signature or PIN code. The seller can lower the risk of fraud by asking whether the card holder is actually the card owner to the service provider. Upon verification from the Application Service Provider (ASP), the Seller can assign receivables to the customer credit card with electronic payment methods.

The preceding invention is the US Patent Application no. 2005230522 which is incorporated by reference herein. In that application a secure electronic payment system is described. In that system verification information based on a payment account (meaning a credit card account) is sent to the seller's computer from the verification server via the user's web browser. The seller's computer sends the verification information to the computer system run by the bank organizing the payment account or to a payment organization computer or to the computer of the buyer. The bank's computer verifies the verification request message and produces an authorization response message. The response message is delivered to the seller's computer and through the bank's computer to the buyer's computer. In case the authorization response states that the verification is successful, the transaction is complete.

However the above-described method has a disadvantage that the verification information is not identified and the verification information is provided to the payer.

In contrast, one advantage of this invention is a proposed system where the verification information is not sent to the buyer. For example, this invention may be a method for the verification of information of the person using credit cards in the electronic environment used in electronic commerce applications in a Customer System Operator—ASP and conveying this information to the seller. After the ASP sends the authorization message to the seller, and the seller decides whether or not the trade will continue. The seller decides only whether or not to send a collection message to the bank upon verification. The buyer does not play a direct role in this decision. Upon this verification, it is now possible to use securely the current electronic payment systems.

With this invention, the prior disadvantages are removed by defining the verification information in detail and by sending the verification information to the seller by the ASP (the Customer System Provider—ASP performing the verification). Further, with this invention, a secure e-commerce possibility is provided by taking the user information automatically using CPUID enablement organized by the user during the e-commerce process and having this information verified. In this system it is impossible to use the system without the user's cooperation. The user has the right to show or not to show the CPUID of his/her computer.

### SUMMARY

This invention is a credit card user identification verification method used during an e-commerce transaction comprising the steps of: obtaining a credit card number information of a customer provided to a data area in an e-commerce site of a seller using an internet browser; obtaining a CPUID information from the internet browser of the customer used in the e-commerce transaction using a component installed with the internet browser; obtaining an internet protocol address information of the customer including the internet connection definitions thereof, obtaining an invoice address information of the customer for the service and product which the customer is buying; sending the credit card number information; the CPUID information; the internet protocol address information, and the invoice address information to an ASP via an internet connection; comparing and verifying the credit card number information; the CPUID information; the internet protocol address information, and the invoice address information to an ASP database; and providing the comparison and verification information to the seller wherein the seller can allow or deny the e-commerce transaction.

### BRIEF DESCRIPTION OF THE DRAWINGS

FIG. 1 is a schematic diagram of a preferred embodiment of the invention method.

### DESCRIPTION OF THE INVENTION

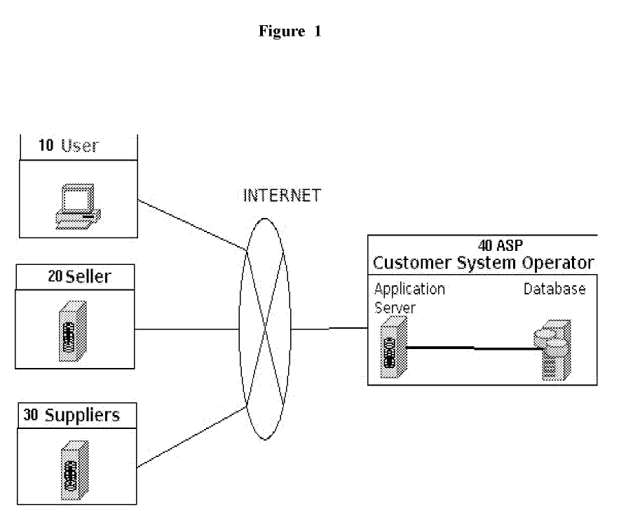

The invention will be described in detail referring the process chart provided in FIG. 1 showing schematically the connectivity using the internet between the user (customer) 10, the seller 20, supplier(s) 30 and the ASP (also know as a “customer system operator”) 40 preferably comprising an application server connected to a data base.

A seller operating on the Internet (from now on will be referred as “seller”) prior to connecting to a payment system (Banks or other Internet payment systems such as Pay pal, etc), with the help of a web browser that the credit card user connects to the seller will forward the credit card number, invoice address, internet protocol (“IP”) address and Central Processing Unit Identification Number (“CPUID”) to the Customer system provider (Application Service Provider—ASP) to check whether he/she is actually the credit card owner and will decide whether the trade will continue.

The ASP information database to be used for verification of the credit card user will be composed of buyer's credit card number and buyer's statement address, the Central Processing identification number (CPUID) and the invoice address, IP address and internet subscription invoice date information. A preferred process is as follows:
The seller, during the trade, before connecting to any payment system (such as various banks, online payment systems such as Pay pal, etc) connects to the customer system provider (Application Service Provider—ASP) and verifies whether or not the credit card user is actually the real credit card owner.
The ASP, requires the following information to verify whether or not the credit card user is actually the real credit card owner:
   Credit card number
   Invoice Address
   Customer IP address
   The CPUID of the computer the customer is using

This information is sent to the seller through the customer web browser. The seller delivers this information to the ASP he/she is subscribed to. The characteristics of the ASP are:
The ASP has a database. Sellers that have a subscription may make a customer verification query from this database by sending the above information. In this database there is the below information provided by the suppliers:
   Customer CPUID and its invoice address. This information is obtained from computer sellers. In theory during the sale of every computer the CPUID and the buyer address will be registered to a database.
   Customer's IP address and the invoice address. This information is obtained from the Internet Service Providers (ISP). In theory every ISP is keeping the IP of the invoice address of all his/her customers. In a database.
   Customer credit card number and statement-invoice address. This information is obtained from credit card providers (banks, financial institutions).
ASP compares this information and gives information about the correctness of the customer to the seller. It is checked whether the seller is subscribed for such a service. The seller must have sent the seller name, seller user password, customer credit card number, customer IP address, CPUID and customer invoice address. For this transaction User table is used. If the user name and password is correct the other customer information and addresses are compared. During this comparison CPUID, IP address and credit card tables are used. In case the comparison results with the fact that the customer is the actual customer the web service sends a “00-Successfully Validated” message to the seller. In case there is a fault one of the following messages will be sent
   “01—Invalid CPUID”
   “02—Invalid IP Address”
   “03—Invalid Credit Card Number”
   “04—Invalid Username or Password”
The seller evaluates the information received from the ASP and decides whether or not to collect the cost of the product from the credit card used in the trade.

With this invention e-sellers will be able to verify their e-customers in the most correct and secure way and reduce risks to minimum and this will ease the prevalence of e-commerce.

The downloaded component is actually an ActiveX component written in Visual Basic 6.0. This downloaded component uses Microsoft Windows Management Instrumentation to detect the CPUID. A preferred embodiment of this program is; for example:
1. A merchant calls the web service in the Application Service Provider. The web service has a web method called CheckPc. Merchant calls the web service in the following format.

Result= x.CheckPC(UserName, Password, CreditCardNumber,
IPAddress,CPUID, BillingAddress)

The merchant sends it is subscription username, subscription password, Buyer's credit card number, buyers IP address, buyers CPUID and buyers billing address to the Application Service Provider. Credit Card Number and Billing Address are provided by buyer to the merchant. Ip address can be determined by an ASP.net code like the following.
IPAddress.Text=Request.Servervariables.Item(“REMOTE_ADDR”)
Full ASP.NET sample code that is calling the Application Service Provider web service on “payment.aspx” file in the “simulator/test” folder is generally known and available; for example:

```
<%@ Page Language=“vb” AutoEventWireup=“false” %>
<%@ Assembly Src=“Reference.vb” %>
<HTML>
    <HEAD>
        <title<VATAN Dergi Grubu Online Abonelik Merkezi</title> </SCRIPT>
        <meta http-equiv=“Content-Language” content=“tr”>
        <meta content=“Microsoft FrontPage 5.0” name=“GENERATOR”>
        <meta content=“FrontPage.Editor.Document” name=“ProgId”>
        <meta http-equiv=“Content-Type” content=“text/html; charset=windows-
1254”>
        <LINK href=“styles.css” type=“text/css” rel=“stylesheet”>
        <script runat=server>
  Private Sub Page_Load(ByVal sender As System.Object, ByVal e As System.EventArgs)
Handles MyBase.Load
    If Page.IsPostBack = False Then
        IPAddress.Text = Request.ServerVariables.Item(“REMOTE_ADDR”)
        SendApproval.Attributes.Add(“OnClick”, “CPUID.value=PCDNACtrl.CPUID;”)
    End If
  End Sub
  Private Sub SendApproval_Click(ByVal sender As System.Object, ByVal e As
System.EventArgs)
    Dim x As New com.somee.selimbayhan.PCDNA
    Result.Text = x.CheckPC(“vdg”, “123456”, CreditCardNumber.Text, IPAddress.Text,
CPUID.Value, BillingAddress.Text)
  End Sub
        </script>
    </HEAD>
    <body bgColor=“#678fc3” topMargin=“0”>
        <form id=“Form1” runat=“server”>
            <table id=“AutoNumber4” style=“BORDER-COLLAPSE: collapse”
borderColor=“#111111” height=“388”
                cellSpacing=“0” cellPadding=“0” width=“632” border=“0”>
                <tr>
                    <td class=“indirimyeni” align=“center” width=“100%”
bgColor=“#d73442” height=“18”><b>CREDIT
                            CARD DATA</b></td>
                </tr>
                <tr>
                    <td width=“100%” bgColor=“#ffffff” height=“5”></td>
                </tr>
                <tr>
                    <td width=“100%” bgColor=“#d6d6d6”>
                        <table id=“AutoNumber5” style=“BORDER-
COLLAPSE: collapse” borderColor=“#111111” cellSpacing=“4”
                            cellPadding=“4” width=“100%”
border=“0”>
                            <tr>
                                <td width=“100%”
bgColor=“#ffffff”>
                                    <table
id=“AutoNumber6” style=“BORDER-COLLAPSE: collapse” borderColor=“#111111” cellSpacing=“1”
    borderColorDark=“#a0a0a0” cellPadding=“3” width=“100%” borderColorLight=“#bebebe”
border=“1”>
                                        <TR>
                                            <TD
class=“rightyeni” align=“right” width=“147” bgColor=“#efefef” colSpan=“3”>
    <OBJECT ID=“PCDNACtrl”
CLASSID=“CLSID:282E8A5E-93C8-49CB-8A3A-BDB73AE02686”
CODEBASE=“PCDNA.CAB#version=1,0,0,0” VIEWASTEXT>
</object>
                                            </TD>
                                        </TR>
                                        <TR>
                                            <TD
class=“rightyeni” align=“right” width=“153” bgColor=“#efefef”><B>Billing
Address</B></TD>
                                            <TD
class=“rightyeni” width=“141” bgColor=“#efefef”><asp:textbox id=“BillingAddress”
runat=“server”></asp:textbox></TD>
                                            <TD
class=“rightyeni6” width=“150” bgColor=“#efefef”></TD>
                                        </TR>
                                        <tr>
                                            <td
class=“rightyeni” align=“right” width=“153” bgColor=“#efefef”><b>Credit Card
        Number:</b></td>
                                            <td
class=“rightyeni” width=“141” bgColor=“#efefef”><asp:textbox id=“CreditCardNumber”
runat=“server” CssClass=“inp2” TextMode=“Password”></asp:textbox></td>
                                            <td
class=“rightyeni6” width=“150” bgColor=“#efefef”>&nbsp;<asp:requiredfieldvalidator
id=“CreditCardNumberValidator” runat=“server” Display=“Dynamic”
ControlToValidate=“CreditCardNumber”
        ErrorMessage=“You have to enter a Credit Card.”
Width=“180px”></asp:requiredfieldvalidator></td>
                                        </tr>
                                        <tr>
                                            <td
class=“rightyeni” align=“right” width=“153” bgColor=“#efefef”><b>CVV2:</b></td>
                                            <td
class=“rightyeni” width=“141” bgColor=“#efefef”><asp:textbox id=“CVV2” runat=“server”
CssClass=“inp2” TextMode=“Password” Width=“52px”></asp:textbox></td>
                                            <td
class=“rightyeni6” width=“150” bgColor=“#efefef”>&nbsp;<asp:requiredfieldvalidator
id=“CVV2Validator” runat=“server” Display=“Dynamic” ControlToValidate=“CVV2”
ErrorMessage=“You have to enter CVV2”></asp:requiredfieldvalidator></td>
                                        </tr>
                                        <tr>
                                            <td
class=“rightyeni” align=“right” width=“153” bgColor=“#efefef”><b>Expire Date:</b></td>
                                            <td
class=“rightyeni” width=“141” bgColor=“#efefef”><asp:textbox id=“ValMonth”
runat=“server” CssClass=“inp2” TextMode=“Password”
Width=“52px”></asp:textbox><asp:textbox id=“ValYear” runat=“server” CssClass=“inp2”
TextMode=“Password” Width=“52px” DESIGNTIMEDRAGDROP=“419”></asp:textbox></td>
                                            <td
class=“rightyeni6” width=“150” bgColor=“#efefef”>&nbsp;</td>
                                        </tr>
                                        <tr>
                                            <td
class=“rightyeni” align=“right” width=“153” bgColor=“#efefef”><b>Amount:</b></td>
                                            <td
class=“rightyeni” width=“141” bgColor=“#efefef”>&nbsp;45.87 USD</td>
                                            <td
class=“rightyeni6” width=“150” bgColor=“#efefef”>&nbsp;</td>
                                        </tr>
                                        <TR>
                                            <TD
class=“rightyeni” align=“right” width=“153” bgColor=“#efefef”><B>CPUID:</B></TD>
                                            <TD
class=“rightyeni” width=“141” bgColor=“#efefef”><input class=“inp2” id=“CPUID”
type=“text” size=“30” name=“CPUID” runat=“server”></TD>
                                            <TD
class=“rightyeni6” width=“150” bgColor=“#efefef”></TD>
                                        </TR>
                                        <TR>
                                            <TD
class=“rightyeni” align=“right” width=“153” bgColor=“#efefef”><B>IP Address:</B></TD>
                                            <TD
class=“rightyeni” width=“141” bgColor=“#efefef”><asp:textbox id=“IPAddress”
runat=“server” Width=“192px”></asp:textbox></TD>
                                            <TD
class=“rightyeni6” width=“150” bgColor=“#efefef”></TD>
                                        </TR>
                                        <tr>
                                            <td
class=“rightyeni” align=“center” width=“550” bgColor=“#e1e8f2”
colSpan=“3”>&nbsp;<asp:button id=“SendApproval” runat=“server” Text=“Send”
cssclass=“inpbtn” onclick=“SendApproval_Click”></asp:button></td>
                                        </tr>
                                    </table>
                                </td>
                            </tr>
                        </table>
                    </td>
                </tr>
            </table>
            <p><asp:label id=“Result” runat=“server”></asp:label></p>
            </TD><td bgColor=“#ffffff” width=“5”>&nbsp;</td>
            </TR></TBODY></TABLE></form>
    </body>
</HTML>
```

2. In a payment.aspx file there may be an embedded activeX object (CAB file) this file is generated with VB 6.0 compiler to determine the CPUID of the buyer PC; for example:

<OBJECT ID=“PCDNACtrl”
CLASSID=“CLSID:282E8A5E-93C8-49CB-8A3A-BDB73AE02686”
CODEBASE=“PCDNA.CAB#version=1,0,0,0” VIEWASTEXT>
</object>

This component is using Windows Management Objects to determine CPUID and MAC address of the buyers PC.

```
Property Get MAC( ) As String
    Dim oWMI, oMac
    Set oWMI = GetObject(“winmgmts:”)
    For Each oMac In
    oWMI.InstancesOf(“Win32_NetworkAdapterConfiguration”)
        MAC = oMac.MacAddress
    Next
End Property
Property Get CPUID( ) As String
    Dim oWMI, oCpu
    Set oWMI = GetObject(“winmgmts:”)
    For Each oCpu In oWMI.InstancesOf(“Win32_Processor”)
        CPUID = oCpu.ProcessorId
    Next
End Property
```

3. Application service Provider may use a preferred algorithm for determining the buyer; for example:

```
Public Function CheckPC(ByVal UserName As String, ByVal Password
As String, ByVal CreditCardNumber As String, ByVal IPAddress As
String, ByVal CPUID As String, ByVal Address As String) As String
        If Authenticated(UserName, Password) Then
            If IsMatchCreditNumber(CreditCardNumber, Address)
            Then
                If IsMatchIPAddress(IPAddress, Address) Then
                    If IsMatchCPUID(CPUID, Address) Then
                        Return “00 - PC Succesfully Validated”
                    Else
                        Return “01 - Invalid CPUID”
                    End If
                Else
                    Return “02 - Invalid IP Address”
                End If
            Else
                Return “03 - Invalid Credit Card Number”
            End If
        Else
            Return “04 - Invalid UserName or Password”
        End If
        End Function
```

Authenticated function in this algorithm returns if the merchant is authenticated. If it is authenticated IsMatchCreditCard Function is used to determine Credit Card number and Billing Address are matching. If they are matching IsmatchIPaddress function is used to determine IP address and Billing address are matching. If they are matching IsMatchCPUID function is used to determine CPUID and billing address are matching. If all of them matches it send a “00—PC Succesfully Validated” to the merchant who calls the web service. If one of them fails it sends the appropriate messages shown in the code; for example:

For test purposes there is an hypothetical database in the Application Service Provider. This database has the following tables. And web service looks for these tables to validate the PC.

CPUIDs Table

This table has the CPUIDs and their matching billing addresses.

| Field name | Field Type | Field Length | Field Description |
|---|---|---|---|
| CPUID | Alphanumeric | 16 | Central processing Unit ID |
| Address | Alphanumeric | 255 | Billing Address |

Sample Record:

CPUIDs

| CPUID | Address |
|---|---|
| 00000055561A0F22 | Büyükdere Cad. No: 124 Mecidiyeköy/Istanbul |

CreditCards Table

This table has the Credit Card numbers and their matching billing addresses.

| Field name | Field Type | Field Length | Field Description |
|---|---|---|---|
| CreditCardNumber | Alphanumeric | 20 | Credit Card Number |
| Address | Alphanumeric | 255 | Billing Address |

Sample Record:

CreditCards

| CreditCardNumber | Address |
|---|---|
| 1234567890123456 | Büyükdere Cad. No: 124 Mecidiyeköy/Istanbul |

Important Note: For simulation purposes credit card number in this database is clear text. In real world it is generally hashed with an industry standard hashing algorithm.

IP Addresses Table

This table has the IP addresses and their matching billing addresses.

| Field name | Field Type | Field Length | Field Description |
|---|---|---|---|
| IPAdress | Alphanumeric | 15 | IP address |
| Address | Alphanumeric | 255 | Billing address |

Sample Record:

IPAddresses

| IPAddress | Address |
|---|---|
| 191.163.99.33 | Büyükdere Cad. No: 124 Mecidiyeköy/Istanbul |

Users Table

This table has the merchant usernames and passwords.

| Field name | Field Type | Field Length | Field Description |
|---|---|---|---|
| UserName | Alphanumeric | 10 | User name |
| Password | Alphanumeric | 16 | Password |

Sample Record:

Users

| UserName | Password |
|---|---|
| amazon.com | 123456 |

Important Note: For simulation purposes password in this database is clear text. In real world it it is generally hashed with an industry standard hashing algorithm.

An example of a simulation database in the following MS Access file are explained above in the tables and structures.

What is claimed is:

1. A credit card user identification verification method used during an e-commerce transaction comprising the steps of:
Obtaining a credit card number information of a customer provided to a data area in an e-commerce site of a seller using an internet browser;
Obtaining a CPUID information from the internet browser of the customer used in the e-commerce transaction using a component installed with the internet browser;
Obtaining an internet protocol address information of the customer including the internet connection definitions thereof;
Obtaining an invoice address information of the customer for the service and product which the customer is buying;
Sending the credit card number information; the CPUID information; the internet protocol information, and the invoice address information to an ASP via an internet connection;
Comparing and verifying the credit card number information; the CPUID information;
the internet protocol information, and the invoice address information to an ASP database; and
Providing the comparison and verification information to the seller wherein the seller can allow or deny the e-commerce transaction.

2. The credit card user identification verification method of claim 1 wherein the step of providing the comparison and verification information to the seller further comprises providing messages selected from the group consisting of “01—Invalid CPUID”, “02—Invalid IP Address”, “03—Invalid Credit Card Number”, and “04—Invalid Username or Password”, and combinations thereof.

3. The credit card user identification verification method of claim 2 further comprising installing a component for use with the internet browser so that the CPUID may be obtained.

4. The credit card user identification verification method of claim 3 further comprising downloading a component for use with the internet browser so that the CPUID may be obtained.

5. The credit card user identification verification method of claim 1 further comprising installing a component for use with the internet browser so that the CPUID may be obtained.

6. The credit card user identification verification method of claim 5 further comprising downloading a component for use with the internet browser so that the CPUID may be obtained.

7. A credit card user identification verification method used during an e-commerce transaction comprising the steps of: downloading a component for use with the internet browser; installing a component so that a CPUID may be transmitted; transmitting the CPUID to an ASP; comparing and verifying the CPUID to an ASP database; and providing the verification to a seller.
